(19) United States
(12) Patent Application Publication
(10) Pub. No.: US 2008/0060750 A1
(43) Pub. Date: Mar. 13, 2008

(54) METHOD AND APPARATUS FOR CREATING RFID DEVICES USING PENETRABLE CARRIER

(75) Inventors: Haochuan Wang, South Pasadena, CA (US); Ali Mehrabi, Glendale, CA (US); Stephen Li, Huntington Beach, CA (US); Kouroche Kian, Altadena, CA (US); Xiaoming He, Arcadia, CA (US); Peikang Liu, Claremont, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: AVERY DENNISON CORPORATION, Pasadena, CA (US)

(21) Appl. No.: 11/469,370

(22) Filed: Aug. 31, 2006

(51) Int. Cl. B65C 9/18; G08B 13/14; H01Q 17/00; H01R 43/00

(52) U.S. Cl. 156/238; 29/601; 29/825; 340/572.8

(57) ABSTRACT

A method for assembling a semiconductor device from a plurality of chips is disclosed. The method includes providing a penetrable carrier having a penetrable carrier substrate and an adhesive layer; providing a plurality of chips disposed on a surface of the adhesive layer; providing a second substrate; bringing the surface of the adhesive layer of the penetrable carrier close to the second substrate; pinning the plurality of chips against the second substrate through the penetrable carrier; and, moving the penetrable carrier away from the second substrate such that the plurality of pinned chips are removed from the surface of the adhesive layer on the penetrable carrier.

### BACKGROUND

1. Field

The present invention relates generally to manufacturing of semiconductor devices, and more particularly, to a method and apparatus for creating RFID devices.

2. Background

Automatic identification of products has become commonplace. For example, the ubiquitous barcode label, placed on food, clothing, and other objects, is currently the most widespread automatic identification technology that is used to provide merchants, retailers and shippers with information associated with each object or item of merchandise.

Another technology used for automatic identification products is Radio Frequency Identification (RFID). RFID uses labels or “tags” that include electronic components that respond to radio frequency commands and signals to provide identification of each tag wirelessly. Generally, RFID tags and labels comprise an integrated circuit (IC, or chip) attached to an antenna that responds to a reader using radio waves to store and access the ID information in the chip. Specifically, RFID tags and labels have a combination of antennas and analog and/or digital electronics, which often includes communications electronics, data memory, and control logic.

One of the obstacles to more widespread adoption of RFID technology is that the cost of RFID tags is still relatively high as high speed and lower cost manufacturing of RFID tags has not been achievable using current production methods. Additionally, as the demand for RFID tags has increased, the pressure has increased for manufacturers to increase the production speed and reduce the cost of the tags, as well as to reduce the size of the electronics as much as possible so as to: (1) increase the yield of the number of chips (dies) that may be produced from a semiconductor wafer, (2) reduce the potential for damage in the assembly process, as the final device size is smaller, and (3) increase the amount of flexibility in deployment.

There are at least two approaches to assembling RFID IC chips with antennas and/or other electronic components. The IC chips are manufactured on a wafer and are typically delivered as a diced wafer attached to a wafer tape. The antennas are typically printed or pattern-coated onto a flexible web. In the first approach, manufacturers use precision pick-and-place machines to bond and electrically connect the bare IC chips directly to the other device components (e.g., antenna) without any intermediate connecting leads. A bare die pick-and-place machine can be easily converted for such an application, in which each bare die is picked directly from the wafer (followed by flipping or no flipping) and then placed and bonded with the antenna. Optionally, one machine can be used to sort the die from a wafer to a more organized format (such as punch tape, reel, or waffle pack) and then a second machine places the die from the more organized format to the final substrate. The second machine can be fed not only with bare dies but also other electronic components (such as IC chips, resistors, LEDs, etc). These electronic components can be placed into the substrate circuitry in a single process. For RFID devices with complex functionality that require extra components other than an IC chip and a film antenna, having bare dies sorted in a intermediate format could have a significant advantage. However, sorting the die from the wafer onto the shuttle, tape, or waffle pack not only adds additional process steps, but can be very expensive as well.

The second route of RFID assembly uses an intermediate connection lead instead of bonding bare dies directly onto the substrates. As the chips become smaller, the process of interconnecting IC chips with antennas becomes more difficult. Thus, to interconnect the relatively small IC chips to the antennas in RFID inlays, intermediate structures variously referred to as “strap leads,” “interposers,” and “carriers” are sometimes used to facilitate inlay manufacture. The intermediate structures include conductive leads or pads that are electrically coupled to the contact pads of the chips for coupling the chips to the antennas. These leads provide a larger effective electrical contact area between the chips and the antenna than do the contact pads of the chip alone. With the use of the intermediate structures, the alignment between an antenna and a chip does not have to be as precise during the direct placement of the chip on the antenna as without the use of such strap leads. The intermediate structure can be bonded and electrically connected to the antenna using web-based converting technologies or surface mount technologies (SMT). The larger contact area provided by the intermediate structures reduces the accuracy required for placement of the chips during manufacture while still providing effective electrical connection between the chip and the antenna. However, the accurate placement and mounting of the dies onto the intermediate structures still provide serious obstacles for high-speed manufacturing of RFID tags and labels.

Some challenges that currently face manufacturers or suppliers to component manufacturers include:

1) Wafer Preparation: Conversion (or sorting) of dies (i.e., chips) from a wafer to a form suitable for high-speed chip dispensing needs to become more cost-effective without sacrificing overall yield.

2) Chip Placement: Accurately positioning of chips for attachment to intermediate structures (e.g., strap leads) or to antennas is difficult to achieve at the speeds needed to achieve the economies of scale obtainable through high volume manufacturing.

3) Bonding: It is difficult to accurately and adhesively bond, cure, and electrically connect the chips to intermediate structures (e.g., strap leads) or to antennas at rates necessary to achieve high volume manufacturing.

Several possible high-speed intermediate structure assembly strategies have been proposed. The first approach, which uses high-speed “pick-and-place” machines, is accurate, but requires expensive chip placement machines that ultimately do not deliver a sufficient throughput to justify the increased cost. That is, pick and place equipment may only be able to achieve 20-25,000 units per hour (uph) whereas 100,000 uph or more is needed for true high speed manufacturing. However, utilizing multiple pick and place machines in a line significantly increases the complexity of the manufacturing process and the possibility of error.

Another approach, referred to as a “self-assembly process,” is a method in which multiple chips are first dispersed in a liquid slurry, shaken and assembled into a substrate containing chip receiving recesses. Some current processes are described in U.S. Pat. No. 6,848,162, entitled “Method and Apparatus for High Volume Assembly of Radio Frequency Identification Tags,” issued to Arneson, et al. on Feb. 1, 2005; U.S. Pat. No. 6,566,744, entitled “Integrated Circuit Packages Assembled Utilizing Fluidic Self-Assembly,” issued to Gengel on May 20, 2003; and, U.S. Pat. No. 6,527,964, entitled “Methods and Apparatuses for Improved Flow in Performing Fluidic Self Assembly,” issued to Smith et al. on Mar. 4, 2003. Publications, patents and patent applications are referred to throughout this disclosure. All references cited herein are hereby incorporated by reference.

Accordingly, there is a long-felt, but as yet unsatisfied need in the RFID device manufacturing field to be able to produce RFID devices in high volume, and to assemble them at much higher speed per unit cost than is possible using current manufacturing processes.

### SUMMARY OF THE PREFERRED EMBODIMENTS

This invention is intended to provide a low cost and high throughput solution to the challenges of wafer preparation and chip placement.

In one preferred embodiment, a method for assembling a semiconductor device from a plurality of chips is disclosed. The method includes providing a penetrable carrier having a penetrable carrier substrate and an adhesive layer; providing a plurality of chips disposed on a surface of the adhesive layer; providing a second substrate; bringing the surface of the adhesive layer of the penetrable carrier close to the second substrate; pinning the plurality of chips against the second substrate through the penetrable carrier; and, moving the penetrable carrier away from the second substrate such that the plurality of pinned chips are removed from the surface of the adhesive layer on the penetrable carrier.

In another preferred embodiment, a structure is disclosed herein having a first layer comprising a penetrable carrier substrate and a layer of adhesive; a second layer comprising a second substrate comprising a plurality of contacts disposed on one surface of the second substrate; and, a plurality of semiconductor devices disposed between the layer of adhesive and the plurality of contacts.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a high-level flow diagram of a method for manufacturing a semiconductor device in accordance to a preferred embodiment of the present invention;

FIG. 2 is a side view of a plurality of chips located on a penetrable carrier pursuant to one preferred embodiment of the present invention;

FIG. 3 is a side view of the plurality of chips of FIG. 2 located between the penetrable carrier and a device web pursuant to one preferred embodiment of the present invention;

FIG. 4 is a side view of the structure of FIG. 3 before an array of pins is used to secure a subset of the plurality of chips to the device web pursuant to one preferred embodiment of the present invention;

FIG. 5 is a side view of the structure of FIG. 3 wherein the array of pins is used to secure a subset of the plurality of chips to the device web pursuant to one preferred embodiment of the present invention;

FIG. 6 is a side view of the structure of FIG. 3 wherein a subset of the plurality of chips that is not secured to the device web by the array of pins is removed pursuant to one preferred embodiment of the present invention;

FIG. 7 is a side view of the structure of FIG. 3 wherein the array of pins is removed pursuant to one preferred embodiment of the present invention; and,

FIG. 8 is a top plan view of a plurality of chips being transferred from a penetrable carrier to a plurality of device webs pursuant to one preferred embodiment of the present invention.

Like numerals refer to like parts throughout the several views of the drawings.

### DETAILED DESCRIPTION

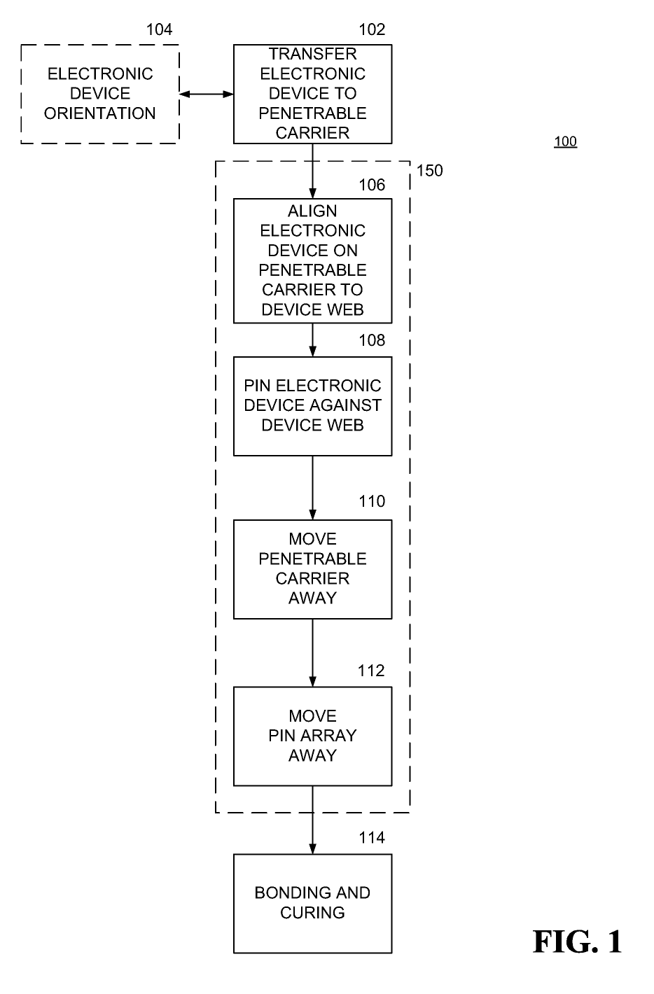

FIG. 1 is a high-level overview of one preferred embodiment of a process 100 for the creation of an electronic device assembly, adapted for the manufacturing of RFID devices. In general, the process 100 as illustrated involves different stages, including, as further detailed herein: a electronic device transfer stage 102, during which a plurality of electronic devices (e.g., dies or chips) is transferred from the wafer to a penetrable carrier (one-by-one or batch-by-batch), such as a mesh web with an adhesive layer disposed thereon; an optional electronic device orientation stage 104, during which the orientation of the electronic devices is adjusted so that the contact pad side is either up or down, as desired; an electronic device placement process 150, where the electronic devices are transferred from the penetrable carrier to a second carrier, such as a strap lead web having a plurality of strap leads displaced thereon (e.g., the electronic devices on the penetrable carrier are transferred from the mesh web and each attached to a respective strap lead on the strap lead web); and a bonding and curing stage 114, during which the electronic devices are simultaneously bonded to the second carrier and the adhesive cured.

In one preferred embodiment, the electronic device placement process 150 includes the following stages: a penetrable carrier and second carrier alignment stage 106, during which the electronic devices on the penetrable carrier are aligned to the second carrier; an electronic device pinning stage 108, where the electronic devices are pinned to the second carrier using an array of pins; a penetrable carrier detachment stage 110, during which the penetrable carrier is moved away from the pinned electronic devices; and a pin array removal stage 112, where the pin array is moved away from the electronic devices that are now attached to the second carrier.

Portions of the electronic device transfer and attachment process described herein may be optional and the described process may include portions that are not needed for a particular application. Therefore, the following description should be read as illustrating exemplary embodiments of a novel electronic device transfer and assembly process as practiced in one preferred embodiment of the present invention and should not be read in a limiting sense. Specifically, the electronic device transfer and assembly process described herein is applied to the assembling of RFID devices, where electronic devices are chips that are being attached to strap leads.

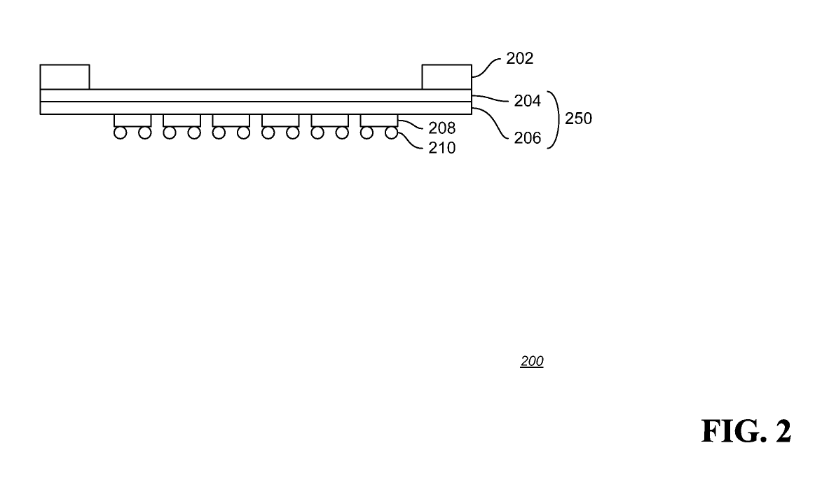

With reference to FIG. 2, process 100 begins with step 102, during which a plurality of chips (i.e., dies) 208 from a wafer have been transferred from the wafer (or sorted out of a wafer one-by-one or batch-by-batch) to a penetrable carrier 250 comprised of a penetrable carrier substrate 204 and held in place by an adhesive layer 206. A plurality of dies may be transferred from the wafer to the carrier simultaneously; or a die testing/sorting machine may be use to test/sort the dies and place them onto the carrier one-by-one with a unique pitch. The penetrable carrier substrate 204, if in the form of a flexible material, may need to have tension applied for mechanical strength and geometric integrity. Typically, the carrier substrate can be stretched and then mounted on a solid, rigid frame with an opening in the middle. Mounting to the frame may utilize structural adhesives or mechanical locking mechanisms. Preferred frame materials have high mechanical strength so the carrier substrate can be stretched and held with high lateral tension. The high lateral carrier substrate tension helps to prevent the carrier substrate from deflecting during the pinning process and during the die-carrier substrate—delaminating process (step 110). The frame may be constructed of a closed form, such as a circle, square, or other geometric configuration. Alternatively, the frame may be constructed of an open form, such as where the frame is comprised of two portions, each clamped onto an edge of a web, and tension is applied to the web through the frame. In the embodiment shown in FIG. 2, the penetrable carrier substrate 204 is mounted on a frame 202. In one preferred embodiment, each chip in the plurality of chips 208 has its contacts 210 facing outwardly from the penetrable carrier substrate 204.

In one preferred embodiment, the penetrable carrier substrate 204 is in the form of a film and the film may have an adhesive disposed on one side. In this embodiment, no hole exists in the penetrable carrier substrate 204 until the carrier substrate is penetrated. In another preferred embodiment, the penetrable carrier substrate 204 is a mesh web with the adhesive layer 206 disposed on one side of the penetrable carrier substrate 204. The mesh web can be made from a material similar to the material that is used for silk screen printing. Typically the mesh web is woven from fibers. The fibers can be polyester, nylon, metal, etc. Further, in this embodiment the adhesive layer 206 may be coated onto the penetrable carrier substrate 204 (i.e., mesh web) such that adhesive will penetrate into holes in the penetrable carrier substrate 204 and form a reinforced composite material. In either embodiment (i.e., where the penetrable carrier substrate 204 is a mesh material or a material with no holes/opening), the adhesive layer 206 may be discontinuous.

The adhesive used in the adhesive layer 206 may be a functional adhesive (switchable adhesive). For example, the adhesive may be a modified permanent or semi-permanent pressure sensitive adhesive (PSA) so that the diced wafer on a wafer tape (with separated dies) can be easily transferred to the penetrable carrier 250. By choosing an appropriate high-adhesion adhesive, the diced wafers can be made to transfer from the wafer tape to the penetrable carrier 250. Later, the pressure sensitive adhesive on the penetrable carrier 250 may be switched off to become a low tack, low adhesion pressure sensitive adhesive. With low adhesion, a die can be easily dispensed to another substrate as long as a pin can penetrate through the penetrable carrier 250 and overcome the residual adhesion force. Examples of functional adhesives include ultraviolet (UV) switchable or temperature switchable PSA. UV detackifiable pressure sensitive tape with a UV detackifiable adhesive is already widely used in the semiconductor industry for wafer grinding, dicing, etc.

The transfer of the wafer comprising the plurality of chips 208 to the penetrable carrier 250 can be accomplished by any known means, including tape-to-tape transfer of the entire wafer using UV or temperature switchable adhesives. In another preferred embodiment, instead of transferring the entire wafer of chips to the penetrable carrier 250, only predetermined portions of the plurality of chips 206 are transferred to the penetrable carrier 250. Thus, for example, only every other chip in each row and column of a wafer may be transferred. In this way, a desired space may be achieved between the chips on the penetrable carrier 250 before the penetrable carrier 250 is brought into contact with the strap lead web 302. In yet another preferred embodiment, a die testing/sorting machine may be use to test/sort the dies and place them onto the carrier one-by-one with a unique pitch. It is also possible that one can eliminate the process of transferring diced wafers to the new carrier simply by dicing the wafer directly on the pin penetrable carrier.

As described herein, a fiber-reinforced composite material comprising a mesh web may be used as the penetrable carrier substrate 204. In one example, a mesh is selected that has a unique mesh count allowing each individual chip to cover about 9 holes of the mesh web (i.e., the penetrable carrier substrate 204) in the penetrable carrier 250. The exact number of holes covered by each chip, the orientation of each chip on the penetrable carrier 250, or whether there is complete coverage of all the holes by the plurality of chips 208 is unimportant, but it is desirable that each chip cover at least one mesh hole so that the chip may be pushed through the hole using a pin, as described herein.

In step 104, which in one preferred embodiment as described herein is a chip orientation stage that may be optional, the orientation of the plurality of chips 208 is adjusted so that the contact pad side of each chip is exposed. Specifically, one or more transfers of the wafer to intermediate support(s) may be required in order to achieve the desired “pads up” or “pads down” orientation of the plurality of chips 208 prior to their transfer to the penetrable carrier 250.

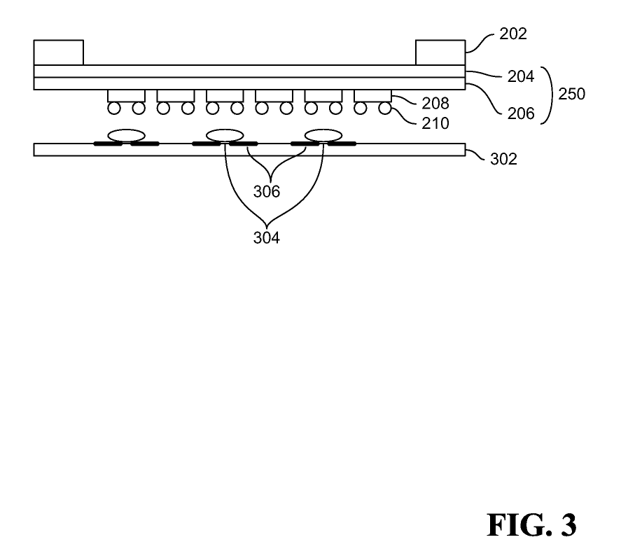

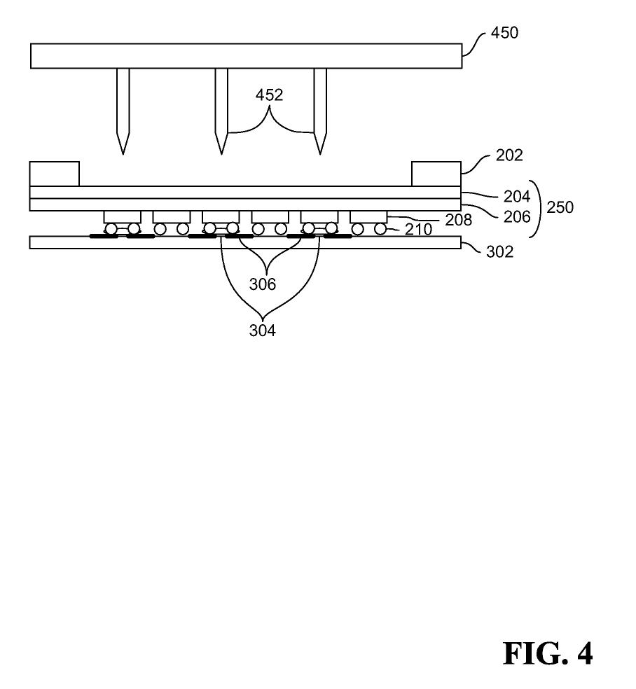

After the plurality of chips 208 has been mounted on the penetrable carrier 250, the chip (i.e., electronic device) placement process 150 continues, as further detailed herein, where chips from the plurality of chips 208 are transferred from the penetrable carrier 250 to a strap lead web 302 and attached to a respective strap lead (i.e., the chips on the penetrable carrier 250 are transferred and each attached to a respective strap lead on a strap lead web). In one preferred embodiment, the chip placement process 150 begins with the penetrable carrier and strap lead (i.e., device) web alignment stage 106, during which chips from the plurality of chips 208 on the penetrable carrier 250 are aligned to and also brought into contact with a plurality of strap contacts 306 on the strap lead web 302, as seen in FIGS. 3 and 4, respectively. Thus, chips from the plurality of chips 208 are aligned and brought into contact with the plurality of strap contacts 306 on the strap lead web 302, sandwiching the plurality of chips 208 between the penetrable carrier 250 and the strap lead web 302. The strap lead web 302 may already comprise electronic components attached to the plurality of strap contacts 306 (only the plurality of strap contacts 306 is shown). The strap lead web 302 also includes a plurality of adhesive spots 304 for adhering the plurality of chips 208 to the respective plurality of strap contacts 306, and effecting electrical contact with the associated electronic components. The adhesive spots can be any of the bonding adhesives used in the semiconductor industry for surface mount assembly of electronic devices. In one preferred embodiment, the plurality of adhesive spots 304 are spots of dispensed Anisotropic Conductive Paste (ACP). The adhesive can also be Nonconductive Paste (NCP) or Isotropic Conductive Paste (ICP).

In one preferred embodiment, because the pitch of the plurality of chips 208 is different than the pitch of the plurality of strap contacts 306, not all chips in the plurality of chips 208 will be transferred in a single step. In other words, when the spacing between the plurality of chips 208 does not match the spacing of the plurality of strap contacts 306, then only a subset of the plurality of chips 208 will be transferred to the plurality of strap contacts 306. In one preferred embodiment, the spacing of the plurality of strap contacts 306 is a whole number multiple of the spacing between the plurality of chips 208,

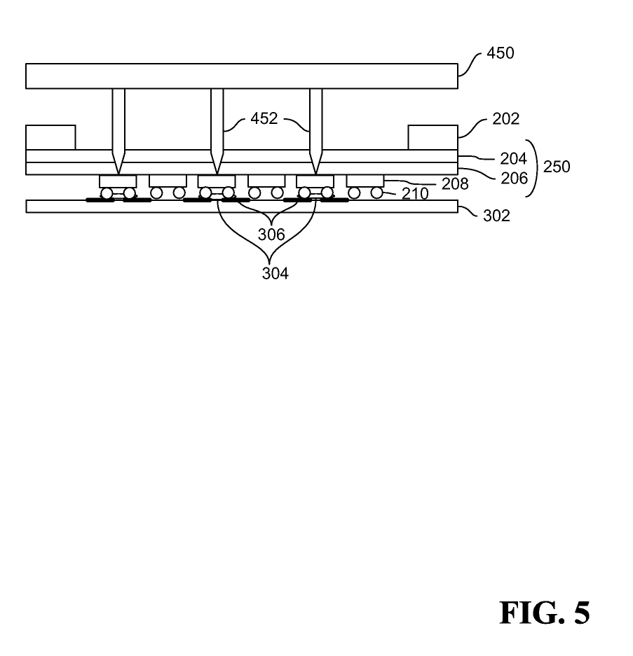

Also illustrated in FIG. 4 is a pin array 450 including a plurality of pins 452, which is used in the chip pinning stage 108 to pin the plurality of chips 208 to the plurality of strap contacts 306. In one preferred embodiment, the plurality of pins 452 are brought into contact with a subset of the plurality of chips 208, penetrating the penetrable carrier 250 in order to make contact with the chips and pushing them firmly against the strap lead web 302 and the adhesive spots 304, as illustrated in FIG. 5. The pins could be fixed or the pins could be spring loaded on the back. The pins are preferably fine, as well as stiff and strong. The pins preferably have tapered body with a pointed tip. The material usable in making pins can include any material that is capable of holding its shape, such as metal, plastic, composites and/or ceramic.

In another preferred embodiment, instead of simultaneously actuating all of the pins, which in the example are spaced at a fixed pitch, pins can selectively be actuated or deployed. In this case, the number of pins used as compared to the number of strap leads on the strap lead web is not a one-to-one relationship and can be a many-to-one (or one-to-many) relationship. Thus, chips can be selectively dispensed by selectively actuating respective pins. Similar to a player piano mechanism, wherein selective pins can be used to trigger the striking of a note, certain ones of the pins in the pin array 450 can be activated to pin selected chips to the strap lead web 302. In addition, rows of pins in the pin array 450 may be used to push chips onto the strap lead web 302. In this case, the pitch of the dispensed chips is determined by which of the pins in the array are activated.

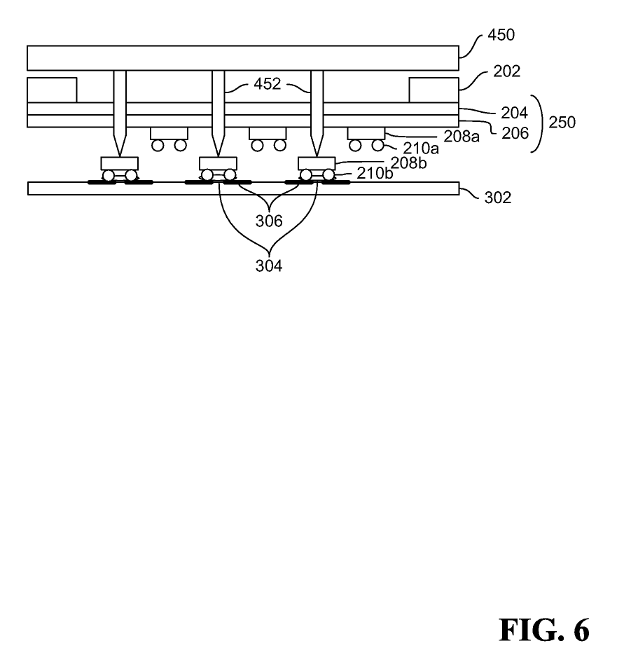

In the penetrable carrier detachment stage 110, as illustrated in FIG. 6, the penetrable carrier 250 is withdrawn (i.e., moved away) from the strap lead web 302, while the plurality of pins 452 holds down a subset of transferred chips 208b, with contacts 210b in contact with plurality of strap contacts 306. Thus, the penetrable carrier 250 and a subset of non-transferred chips 208a, with their associated contacts 210a, are withdrawn to a position of non-contact with the strap lead web 302 while the plurality of pins 452 continue to hold the subset of transferred chips 208b—i.e., the now transferred chips, in contact with the strap lead web 302. In one preferred embodiment, the plurality of pins 452 are of a suitable length to allow the penetrable carrier 250 to move along the shafts of the plurality of pins 452 to a non-contact position.

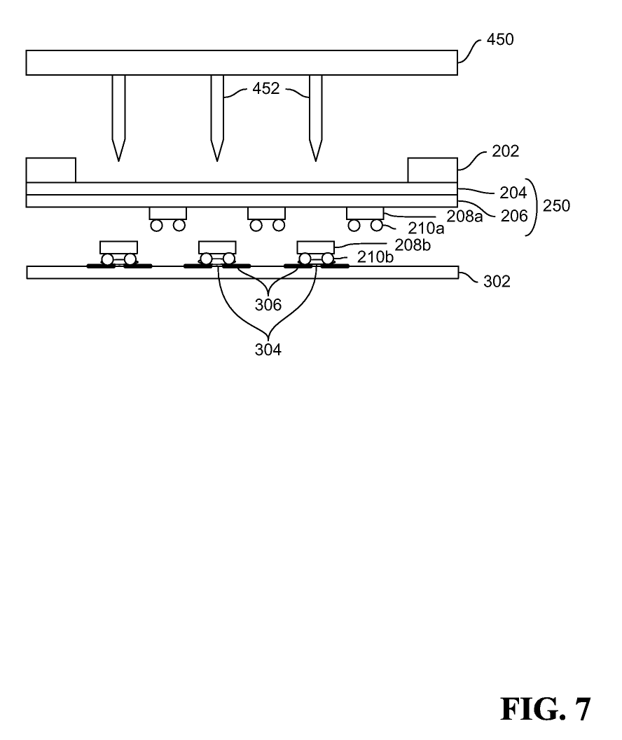

During the pin array removal stage 112, as illustrated in FIG. 7, after the penetrable carrier 250 has been withdrawn in the penetrable carrier detachment stage 110, the pin array 450 is moved away from the strap lead web 302, which leaves the subset of transferred chips 208b attached to the plurality of strap contacts 306 on the strap lead web 302 by the adhesive spots 304.

In one preferred embodiment, the adhesive spots 304 are cured before the plurality of pins 452 are withdrawn. In another preferred embodiment, a separate bonding and curing stage 114 is used to bond the subset of transferred chips 208b to the plurality of strap contacts 306 after the plurality of pins 452 has been removed.

With the transferred dies adhered to the strap lead web 302 by the adhesive spot (cured or uncured), withdrawal of the plurality of pins 452 completes one cycle of transferring the chips to the strap lead web 302, and the penetrable carrier 250 may now be repositioned to transfer additional chips from the subset of non-transferred chips 208a onto another plurality of strap leads. Thus, the process 100 may be repeated until all the chips of the plurality of chips 208 are transferred.

In another preferred embodiment, instead of applying the adhesive 206 onto/into the penetrable carrier substrate 204, the adhesive may be dispensed, or coated, onto the plurality of chips 208. The dies with adhesive are then laminated with the penetrable carrier substrate 204 (whether the substrate is a film, a mesh, etc. Similarly, before the die transfer to the strap/antenna substrate, the adhesive spot (ACP, NCP, etc.) can be applied onto the dies instead of being placed on the substrate. Regardless of how the adhesive spots are dispensed, it is preferred that the adhesive spot volume can be carefully controlled. Too little adhesive will give a weak bond strength, while too much adhesive may cause adhesive paste to be smeared onto the other, adjacent dies or to the substrate.

In one preferred embodiment, assuming wafers are transferred to the penetrable carrier without a change in pitch, multiple strap lead webs can be used, with each strap lead web being in parallel with each other (i.e., side by side). For example, each strap lead web only has a width of one column and corresponds to one column of chips in the wafer. In this way, multiple columns of chips can be dispensed at the same time.

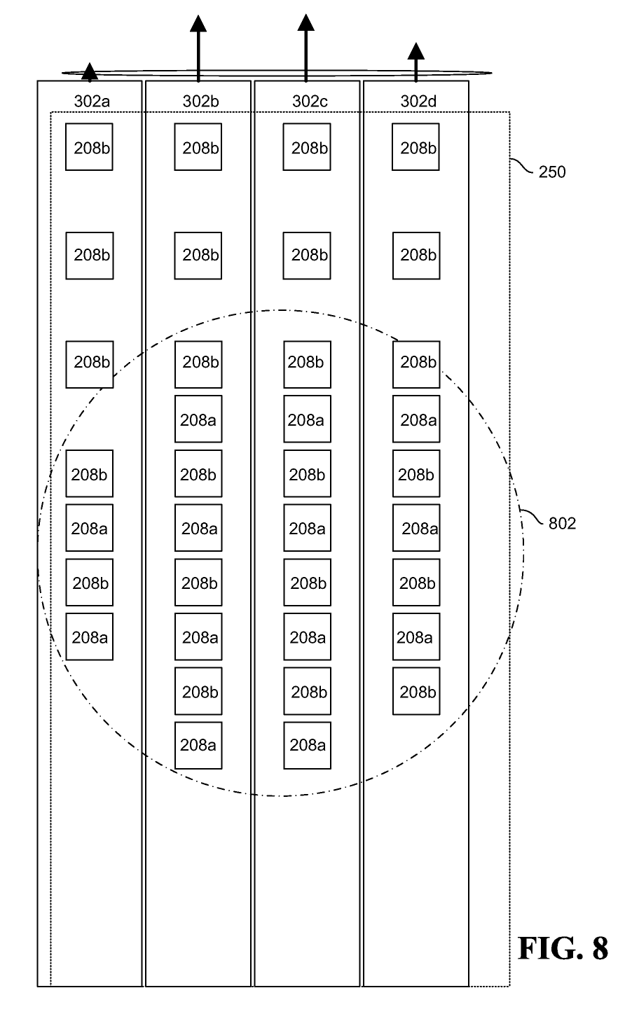

FIG. 8 is a top plan view of the penetrable carrier 250 overlaid on top of a plurality of strap lead webs 302a-302d. The penetrable carrier 250 includes a wafer 802 with chips to be transferred. To simplify the depiction of the figure, no strap leads, strap contacts, adhesive spots or other electrical components are shown. As illustrated, each one of the strap lead webs 302a-302d is moved a different distance at a time depending on which part of the transferred wafer (i.e., the plurality of chips 208) is covered by the respective strap lead web. In the example shown, process 100 has been cycled through several times and thus each of the strap lead webs 302a-302d has a subset of transferred chips 208b. A subset of non-transferred chips 208a remains on wafer 802, ready to be transferred.

Instead of using the ideas in this invention for bonding dies to strap leads or antennas, it is possible to use the method to transfer dies to a unique format for feeding Surface-Mount Technology (SMT) machines. SMT typically requires the components to be fed from a linear tape, a shuttle, or a waffle pack, etc. The machine that transfers dies from a wafer to an appropriate form to feed SMT can be slow and expensive. This invention can be used to prepare and transfer dies from a wafer to an appropriate form (on a tape, a shuttle, a waffle pack, etc.) for feeding the SMT.

It should be noted that the process described herein may be applied not only to the manufacture of RFID devices, but to other kinds of electronic devices, optoelectronic devices or display assemblies that require massive, high speed, and low cost attachment of components to printed circuit boards or flexible electronics webs.

The embodiments described above are exemplary embodiments of the present invention. Those skilled in the art may now make numerous uses of, and departures from, the above-described embodiments without departing from the inventive concepts disclosed herein. Accordingly, the present invention is to be defined solely by the scope of the following claims.

What is claimed is:

1. A method for assembling a semiconductor device from a plurality of chips comprising the steps of:
providing a penetrable carrier having a penetrable carrier substrate and an adhesive layer;
providing a plurality of chips disposed on a surface of the adhesive layer;
providing a second substrate;
bringing the surface of the adhesive layer of the penetrable carrier close to the second substrate;
pinning the plurality of chips against the second substrate through the penetrable carrier; and,
moving the penetrable carrier away from the second substrate such that the plurality of pinned chips are removed from the surface of the adhesive layer on the penetrable carrier.

2. The method of claim 1, wherein providing the penetrable carrier having the adhesive layer comprises providing the penetrable carrier with a layer of functional adhesive.

3. The method of claim 2, wherein providing the penetrable carrier with the layer of functional adhesive comprises providing the penetrable carrier with a temperature sensitive adhesive.

4. The method of claim 2, wherein providing the penetrable carrier with the layer of functional adhesive comprises providing the penetrable carrier with a radiation sensitive adhesive.

5. The method of claim 1, wherein the pinning the plurality of chips comprises inserting a pin through the penetrable carrier and pushing one chip in the plurality of chips against the second substrate.

6. The method of claim 5, wherein the penetrable carrier substrate comprises at least one opening.

7. The method of claim 6, wherein the penetrable carrier substrate comprises a second opening and pinning the plurality of chips comprises inserting a second pin through the penetrable carrier and pushing a second chip in the plurality of chips against the second substrate.

8. The method of claim 5, wherein the penetrable carrier substrate is a mesh.

9. The method of claim 5, wherein the pin comprises a tapered body.

10. The method of claim 5, wherein the pin comprises a blunt end.

11. The method of claim 1, wherein moving the penetrable carrier away from the second substrate comprises keeping the plurality of pinned chips pinned against the second substrate while separating the penetrable carrier from the second substrate.

12. The method of claim 1, further comprising the step of placing an adhesive on the second substrate, wherein the adhesive is disposed between at least one chip in the plurality of chips and the second substrate.

13. The method of claim 1, wherein bringing the penetrable carrier close to the second substrate comprises aligning the penetrable carrier to the second substrate.

14. The method of claim 13, wherein the second substrate comprises a plurality of contacts and wherein aligning the penetrable carrier to the second substrate comprises aligning the plurality of chips to the plurality of contacts.

15. The method of claim 1, wherein the second substrate comprises a plurality of strap leads disposed thereon.

16. The method of claim 15, wherein an Anisotropic Conductive Paste (ACP) is used to connect the plurality of strap leads to the plurality of chips.

17. The method of claim 1, wherein the adhesive layer is embedded in the penetrable carrier substrate, wherein the adhesive layer is exposed through the penetrable carrier substrate.

18. The method of claim 1, wherein the second substrate is an intermediate carrier.

19. A structure comprising:
a first layer comprising a penetrable carrier substrate and a layer of adhesive;
a second layer comprising a second substrate comprising a plurality of contacts disposed on one surface of the second substrate; and,
a plurality of semiconductor devices disposed between the layer of adhesive and the plurality of contacts.

20. The structure of claim 19, wherein the penetrable carrier substrate comprises a plurality of openings.

21. The structure of claim 20, wherein the plurality of openings are expandable.

22. The structure of claim 19, wherein the penetrable carrier substrate is a mesh.

23. The structure of claim 19, further comprising a spot of adhesive between the plurality of semiconductor devices and the plurality of contacts.

24. The structure of claim 19, wherein the layer of adhesive is comprised of a temperature sensitive adhesive.

25. The structure of claim 19, wherein the layer of adhesive is comprised of a radiation sensitive adhesive.

26. The structure of claim 19, wherein the layer of adhesive is comprised of a functional adhesive.

27. The structure of claim 19, wherein the layer of adhesive is embedded within the penetrable carrier substrate.

28. The structure of claim 19, wherein the plurality of semiconductor devices are aligned to the plurality of contacts.
